(19) United States
(12) Patent Application Publication
(10) Pub. No.: US 2026/0307787 A1
(43) Pub. Date: Oct. 8, 2026

(54) Systems and Methods for Manufacturing Composite Laminate Structures

(71) Applicant: Supernal, LLC, Irvine, CA (US)

(72) Inventors: Bryan Marshall, Irvine, CA (US); Michael Devin Shaw, Irvine, CA (US)

(21) Appl. No.: 19/481,883

(22) PCT Filed: May 22, 2024
(86) PCT No.: PCT/US2024/030590

§ 371 Date: Nov. 6, 2025

Related U.S. Application Data
(60) Provisional application No. 63/468,256, filed on May 22, 2023.

(51) Int. Cl. B64C 27/473; B64C 11/26; B64F 5/10

(52) U.S. Cl. CPC B64C 27/473; B64C 11/26; B64F 5/10; B64C 2027/4736

(57) ABSTRACT

A method is disclosed. The method includes applying a layer of braided fiber material around a tool. The method also includes arranging a composite laminate sheet onto the braided fiber material. The method further includes applying an additional layer of braided fiber material on the composite laminate sheet to form a spar. The method additionally includes joining the spar, such that the layers of braided fiber material are fixedly coupled to the composite laminate sheet. The method includes removing the tool from the spar.

### CROSS REFERENCE TO RELATED APPLICATION

The present application claims priority to U.S. Provisional Application No. 63/468,256, filed on May 22, 2023, the entire contents of which are herein incorporated by reference as if fully set forth in this description.

### BACKGROUND

Rotor aircraft utilize a variety of materials, such as thermoset composite (TSC) materials, for the propeller/rotor blades of the aircraft. TSC material propeller/rotor blades may typically consist of several parts (e.g., sub-assemblies). Each part may be individually pre-cured, then the parts may be finally assembled and coupled to form the propeller/rotor blade. The parts may be coupled together through bonding with an adhesive, such as an epoxy resin.

Manufacturing propeller/rotor blades using TSC materials may pose several drawbacks. Automated layup processes for TSC materials, such as automated fiber placement and/or hot drape-forming, may be used for production of certain parts. However, a significant portion of manufacturing propeller/rotor blades from TSC materials may still be performed by hand-layup processes. TSC materials may require lengthy autoclave, press, or oven cure cycles for each sub-assembly, potentially requiring multiple cures per propeller/rotor blade. Further, coupling the sub-assemblies post-cure may require lengthy bond surface preparation to ensure a structurally safe bond is formed between the sub-assemblies. These autoclave or press cure cycles and/or bond surface preparation may result in limited production capability for TSC material propeller/rotor blades.

Because cured TSC materials involve cross-linked polymers, once the part has been cured there may be limited ability to adjust out of tolerance parts. This limited ability to adjust out of tolerance parts may result in requiring stricter manufacturing tolerances to account for the lack of post-cure adjustment, and/or may result in a higher scrap rate of TSC material based rotor blades. Moreover, repairs may be limited for TSC material propeller/rotor blades that have experienced wear or damage through service. Costs associated with manufacturing and using TSC material propeller/rotor blades may be increased as a result of the time consuming and strict standards of production along with high scrap rate due to limited repair options. Thus, there is a need for a method of manufacturing repairable propeller/rotor blades that offer production scalability.

Accordingly, the present invention seeks to produce a propeller/rotor blade that may be repairable and scalable.

### SUMMARY

Embodiments described herein relate to manufacturing composite laminate structures, such as a rotor blade, and more particularly, to systems, methods, and devices for manufacturing thermoplastic composite laminate structures.

In a first embodiment, a method is provided. The method includes applying a layer of braided fiber material around a tool. The method also includes arranging a composite laminate sheet onto the braided fiber material. The method additionally includes applying an additional layer of braided fiber material on the composite laminate sheet to form a spar. The method further includes joining the spar, such that the layers of braided fiber material are fixedly coupled to the composite laminate sheet. The method includes removing the tool from the spar.

In some embodiments, applying the layer of braided fiber material further includes heating the braided fiber material.

In some embodiments, the braided fiber material includes a pre-impregnated thermoplastic carbon fiber.

In some embodiments, the composite laminate sheet includes a thermoplastic matrix.

In some embodiments, the braided fiber material includes a thermoplastic matrix the same as the thermoplastic matrix of the composite laminate sheet.

In some embodiments, the tool includes at least one of an inflatable mandrel, a multi-piece mandrel, or a preform.

In some embodiments, joining the spar includes at least one of co-consolidating, inductive welding, resistance welding, or conductive welding.

In some embodiments, joining the spar further includes applying pressure to a portion of the spar to interact a thermoplastic matrix of the braided fiber material with a thermoplastic matrix of the composite laminate sheet.

In a second embodiment, a spar is provided. The spar includes a first and a second end, where the second end comprises an integrally molded root end joint. The spar also includes a structure defining a cavity. The structure includes one or more layers of thermoplastic impregnated braided fiber material. The single continuous closed structure also includes a thermoplastic composite sheet disposed on a portion of the spar between a first layer and a second layer of the thermoplastic braided fiber material, where a thermoplastic matrix of the thermoplastic composite sheet is joined with a thermoplastic matrix of the thermoplastic impregnated fiber material.

In some embodiments, the thermoplastic matrix of the thermoplastic composite sheet is fused with the thermoplastic matrix of the thermoplastic impregnated fiber material.

In some embodiments, the layer of thermoplastic impregnated braided fiber material is welded with the thermoplastic composite sheet.

In some embodiments, the thermoplastic matrix of the thermoplastic composite sheet is the same as the thermoplastic matrix of the thermoplastic impregnated fiber material.

In some embodiments, the spar includes a monocoque design.

In some embodiments, a length of the spar includes a twist schedule such that a first portion is disposed at an angle to a second portion.

In some embodiments, a space defined by the cavity proximal to the first end is less than a space defined by the cavity proximal to the second end.

In some embodiments, the structure is a single continuous closed structure.

In a third embodiment, a rotor blade is provided. The rotor blade includes a thermoplastic composite spar comprising a first surface, a second surface opposite the first surface, a forward end, and an aft end opposite the forward end. The rotor blade also includes a leading edge assembly comprising a thermoplastic composite skin and disposed at the forward end of the spar, where a portion of the thermoplastic composite skin is coupled to the spar on the first and second surfaces, such that a thermoplastic matrix in the portion of the thermoplastic composite skin is fused with a thermoplastic matrix of the spar. The rotor blade further includes an aft body assembly disposed at the aft end of the spar. The aft body assembly includes a first end and a second end opposite the first end. The aft body assembly also includes a thermoplastic composite upper skin. The aft body assembly further includes a thermoplastic composite lower skin. The upper skin is coupled to the lower skin at the first end and coupled to a first surface of the spar at the second end and the lower skin is coupled to a second surface of the spar at the second end.

In some embodiments, a thermoplastic matrix of the upper skin is fused with a thermoplastic matrix of the lower skin, and wherein a thermoplastic matrix of the spar is fused with (i) the thermoplastic matrix of the upper skin and (ii) the thermoplastic matrix of the lower skin.

In some embodiments, the rotor blade further includes a cavity defined by the aft body assembly, where the cavity includes a foam core.

In some embodiments, the upper and lower skin of the aft body include an integrally formed stiffening member.

In some embodiments, a length of the rotor blade includes a twist schedule such that a first portion of the rotor blade is disposed at an angle to a second portion of the rotor blade.

### BRIEF DESCRIPTION OF THE DRAWINGS

FIG. 1 is a perspective view of a rotor blade, according to exemplary embodiments of the present invention.

FIG. 2 is an exploded view of a rotor blade, according to exemplary embodiments of the present invention.

FIG. 3A is a cross-sectional view of a rotor blade, according to exemplary embodiments of the present invention.

FIG. 3B is an exploded cross-sectional view of a rotor blade, according to exemplary embodiments of the present invention.

FIG. 3C is a cross-sectional view of a rotor blade including a stiffening member, according to exemplary embodiments of the present invention.

FIG. 3D is a close-up perspective view of a stiffening member that may be included on the upper and/or lower aft skins, according to exemplary embodiments of the present invention.

FIGS. 4A-B are cross-sectional views of a spar, according to exemplary embodiments of the present invention.

FIG. 5 is a flow chart of an example method for manufacturing a composite laminate structure, according to exemplary embodiments of the present invention.

FIG. 6 is a flow chart of an example method for manufacturing a rotor blade, according to exemplary embodiments of the present invention.

FIGS. 7A-7B are perspective views of example tools for manufacturing a spar, according to exemplary embodiments of the present invention.

FIG. 8 is a perspective view of an example tool for adjusting dimensions of a rotor blade, according to exemplary embodiments of the present invention.

### DETAILED DESCRIPTION

Disclosed herein are examples describing various features and functions of the disclosed apparatus, processes, and methods with reference to the accompanying figures. The figures are not necessarily to scale and sizes of the various elements may be distorted for clarity. It is understood that various aspects of the disclosed apparatus, processes, and methods can be arranged and combined in a wide variety of different configurations, all of which are contemplated herein. The disclosure generally relates to manufacturing composite laminate structures.

The present application is directed to processes, techniques, and materials for manufacturing composite laminate structures, such as rotor blades and/or components of the rotor blades. In some embodiments, the rotor blade may be part of a vehicle. In some embodiments, the vehicle may be a vertical takeoff and landing (VTOL) aircraft, which may or may not use rotors and/or propellers to hover, take off, and/or land. It should be understood that in other embodiments, the vehicle may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone).

In some embodiments, the vehicle may include a turboprop engine, and the processes, techniques, and materials for manufacturing of composite laminate structures described herein may be applied to a first stage fan of the turboprop engine. Further, in some embodiments, the processes, techniques, and materials for manufacturing of composite laminate structures described herein may be applied to wind turbine blades.

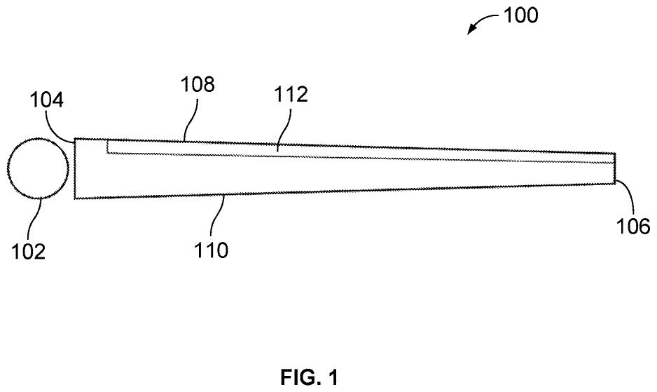

In some embodiments, the vehicle may include one or more rotors and/or propellers used to drive the vehicle. The one or more rotors/propellers may each comprise a plurality of rotor blades, such as rotor blade 100 described below with respect to FIG. 1. The rotor blade 100 may comprise a composite laminate, and may or may not have a cross-sectional airfoil shape. Each propeller may be configured, for example, as tiltrotors, lift rotors, or any other type of rotors. In some embodiments, the vehicle may include one or more turbine engines, one or more tires, one or more ski-structures, or the like instead of the one or more propellers used to drive the vehicle.

FIG. 1 is a perspective view of a rotor blade 100, according to exemplary embodiments of the present invention. The rotor blade 100 may include a root 104 attached to a rotor hub 102, a tip 106 opposite the root 104, a leading edge 108 having a protective material 112, and a trailing edge 110 opposite the leading edge 108. The rotor blade 100 may rotate clockwise or counterclockwise about the rotor hub 102. The rotor blade 100 may comprise any suitable material, for example a composite laminate, and may vary in cross-section thickness from the leading edge 108 to the trailing edge 110, and/or vary in thickness along a length spanning from the root 104 to the tip 106.

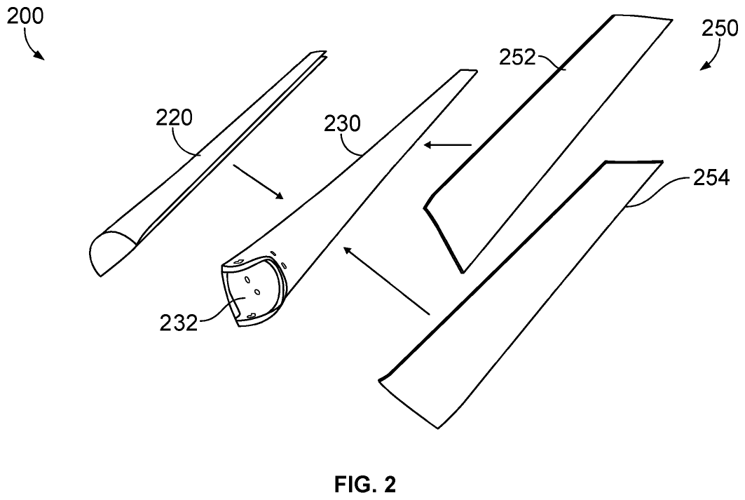

FIG. 2 is an exploded view of a rotor blade 200, according to exemplary embodiments of the present invention. The rotor blade 200 may include a leading edge assembly 220, a spar 230 having an integrally molded root end joint 232, and an aft body assembly 250 having an upper aft skin 252 and a lower aft skin 254. In some embodiments, the leading edge assembly 220, the spar 230, and/or the aft body assembly 250 may be sub-assemblies of the rotor blade 200. Each of the sub-assemblies may be manufactured separately and finally assembled to form the rotor blade 200. In some embodiments, each of the sub-assemblies may comprise a continuous unbroken structure spanning from a root to a tip of the rotor blade 200. For example, the leading edge assembly 220, the spar 230, and/or the upper and lower aft skins 252 and 254 may each be a single unbroken structure.

In some embodiments, final assembly of the rotor blade 200 from the sub-assemblies may be performed without fasteners (e.g., nuts and bolts) or adhesives (e.g., epoxy). For example, the leading edge assembly 220, the spar 230, and/or the aft body assembly 250 may each be made from one or more composite laminates, such as a thermoplastic composite laminate, which may be referred to as a TPC material. A portion of the leading edge assembly 220 may be placed in contact with a first portion of the spar 230. Similarly, a portion of the aft body assembly 250 may be placed in contact with a second portion of the spar 230. In some embodiments, the leading edge assembly 220 may form a butt joint with the aft body assembly 250, encapsulating the spar 230 within the leading edge assembly 220 and the aft body assembly 250. In other embodiments, a portion of the leading edge assembly 220 may form a lap joint (overlap) with the aft body assembly 250 which may encapsulate the spar 230 within the leading edge assembly 220 and the aft body assembly 250. In some embodiments, the exterior surfaces of an encapsulated spar may be completely covered by the leading edge assembly and the aft body assembly.

In some embodiments, coupling may be performed by heating the thermoplastic matrices of respective sub-assemblies. The thermoplastic matrices in portions of the leading edge assembly 220, the spar 230, and/or the aft body assembly 250 that are in contact with each other may interact when heated. Interaction between the respective thermoplastic matrices may allow the thermoplastic matrices to fuse together (e.g., become homogenous at a bond area). Pressure may be applied to encourage interaction of the thermoplastic matrices. In some embodiments, the thermoplastic matrices used in each sub-assembly may be the same and/or substantially similar. Thus, by fusing thermoplastic matrices of the sub-assemblies, the sub-assemblies may be joined to form the rotor blade 200 without the need for fasteners and/or adhesives. Embodiments described herein may increase production rates for rotor blades by reducing processing time traditionally required for TSC materials, such as bond surface preparation, curing time, or autoclave time.

In some embodiments, after the sub-assemblies have been joined to form the rotor blade 200, the rotor blade 200 may be inspected to verify the rotor blade 200 is within tolerance. In embodiments where the rotor blade 200 may be determined to not be within tolerance, the rotor blade 200 may be heated to soften the thermoplastic matrices and then may be adjusted to be within tolerance. For example, the rotor blade 200 may be placed into a tool and or a mold before, during, and/or after heating. The mold may be within dimensional tolerance of a predetermined rotor blade. The softened thermoplastic matrices may allow for the rotor blade 200 to conform to the dimensional tolerance of the mold. For example, the mold may be used to correct a twist schedule of the rotor blade 200.

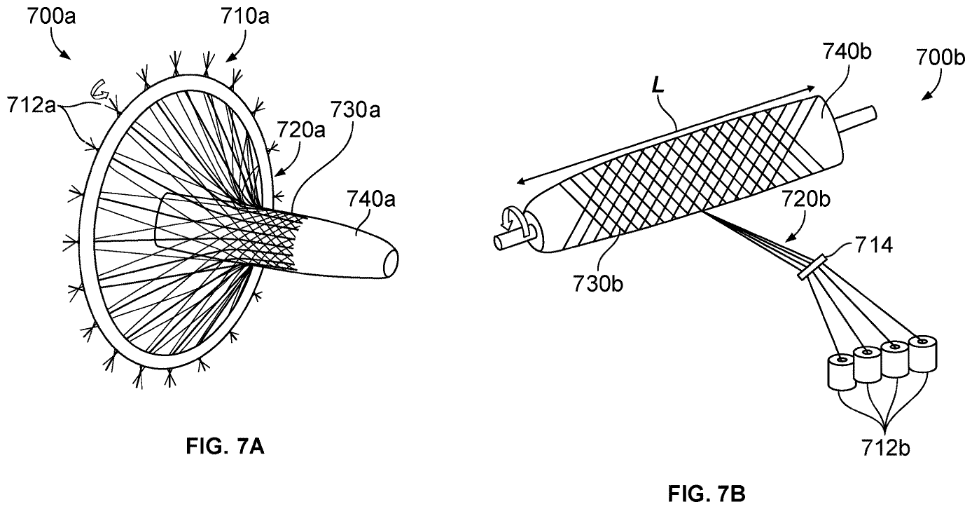

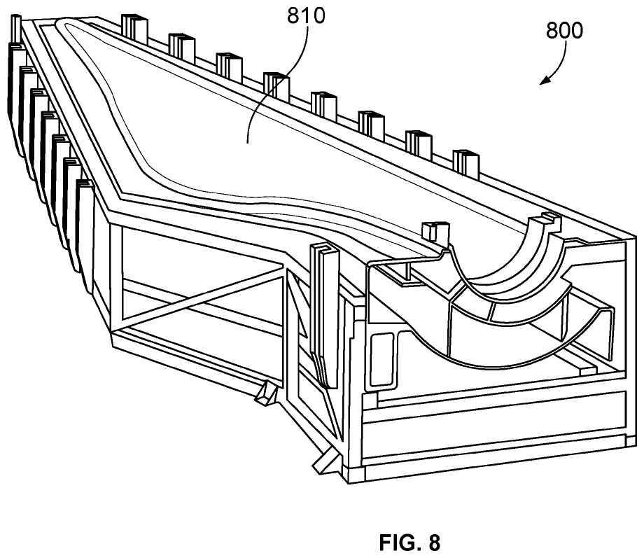

In some embodiments, a process for manufacturing of the rotor blade 200 and/or one or more of the sub-assemblies of the rotor blade 200 may be automated. A robot may be used to carry out the automated process, for example. In some embodiments, the spar 230, the leading edge assembly 220, and/or the aft body assembly 250 may be manufactured using an automated process carried out by the robot. For example, the robot may be controlled to cut one or more thermoplastic composite plies and place the cut thermoplastic composite plies into a mold at determined orientations to form a stackup. Pressure and/or heat may be applied to the stackup such that the thermoplastic composite plies are coupled together to form a thermoplastic composite laminate sheet. In some embodiments, the robot may be controlled to remove the thermoplastic composite laminate sheet from the mold and selectively place the sheet onto determined surfaces of a braided fiber preform, such as a mandrel having a thermoplastic braided fiber wrapped along a perimeter. In some embodiments, one or more layers of braided fiber may be disposed onto the thermoplastic laminate sheet. The preform including the braided fiber and the thermoplastic laminate sheet may be heated to consolidate the respective thermoplastic matrices and fixedly couple the thermoplastic laminate sheet with the braided fiber to form the sub-assembly. In other embodiments, the robot may be controlled to cut and place the one or more thermoplastic composite plies into a mold defining a portion of the leading edge assembly 220 and/or a portion of the aft body assembly 250. An example mandrel is described below in connection with FIGS. 7A and 7B.

In some embodiments, the robot may be controlled to assemble the rotor blade 200 from the leading edge assembly 220, the spar 230, and the aft body assembly 250. The robot may be controlled to pick up the leading edge assembly 220 and mate the assembly to a forward portion of the spar 230. Similarly, the robot may be controlled to pick up the aft body assembly 250 and mate the assembly to an aft portion of the spar 230. Heat and/or pressure may be applied to the mated parts to bond them together to form the rotor blade 200. In embodiments where the leading edge assembly 220, the spar 230, and the aft body assembly 250 include a thermoplastic matrix, heat and/or pressure may encourage interaction between the thermoplastic matrices of the respective parts to join (e.g., by consolidating) the respective parts into the rotor blade 200.

In some embodiments, the composite laminates used in the leading edge assembly 220, the spar 230, and/or the aft body assembly 250 may include multiple types of fibers (e.g., aramid, carbon, or glass), weave or no weave patterns (e.g., chopped, unidirectional, plain weave, 2×2 twill weave, 4×4 twill weave, 5 harness, or 8 harness), and/or matrices (e.g., thermoplastic polymer matrices). Each of the leading edge assembly 220, the spar 230, and/or the aft body assembly 250 may further vary in the number of plies used, the specific ratio of fiber to matrix, and the orientation of the respective plies.

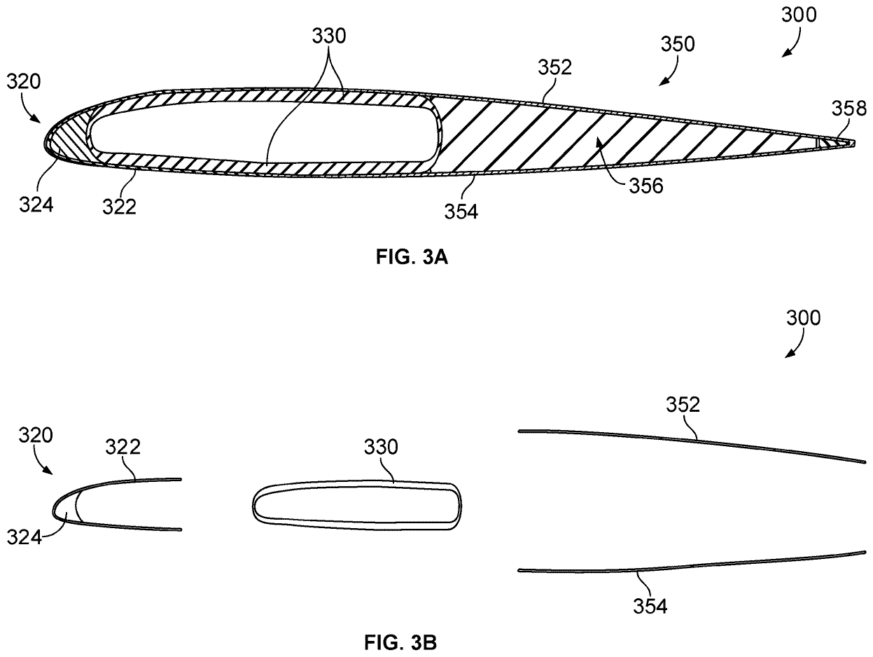

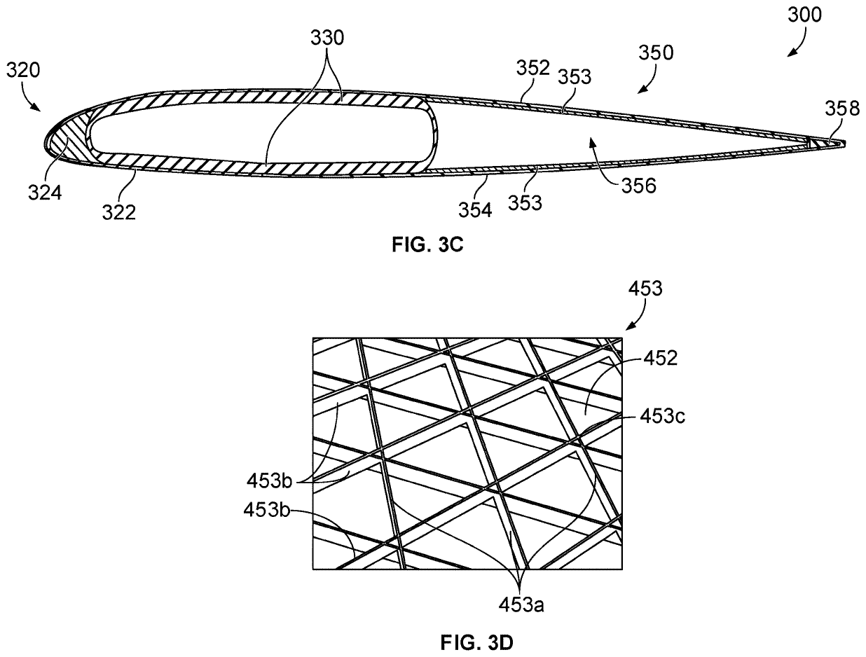

FIG. 3A is a cross-sectional view of a rotor blade 300, according to exemplary embodiments of the present invention. The rotor blade 300 may include a spar 330 coupled to a leading edge assembly 320 and an aft body assembly 350. The leading edge assembly 320 may include a leading edge weight 324 coupled to a leading edge sheath 322. The aft body assembly 350 may include an upper aft skin 352 and a lower aft skin 354 forming a cavity 356. In some embodiments, the cross-section of the rotor blade 300 may form an airfoil shape. However, in other embodiments, the cross-section may form a different shape.

In some embodiments, the leading edge sheath 322 may be a single piece construction made from a thermoplastic composite laminate. The leading edge sheath 322 may be stamped and/or molded to resemble a leading edge of the rotor blade 300. In some embodiments, an unformed (e.g., a blank) thermoplastic composite laminate may be placed into a forming tool, such as a die, for shaping into the leading edge sheath 322. The unformed thermoplastic composite laminate may be a pre-impregnated composite laminate sheet, for example. The unformed thermoplastic composite laminate may be heated before and/or during the stamping or molding process to allow for shaping of the leading edge sheath 322. During the stamping or molding process, pressure and/or heat may be applied by the die as it presses the unformed thermoplastic composite laminate to facilitate forming the shape of the leading edge sheath 322.

However, in other embodiments, the leading edge sheath 322 may be formed through layup of dry fibers, such as carbon fiber plies, onto a tool and/or mold. The dry fibers may be arranged to the desired configuration of the leading edge sheath 322. A resin, such as a thermoplastic matrix, may be applied to the fiber (e.g., resin transfer molding) during processing. The fiber and thermoplastic matrix may cool while against the tool to form a rigid structure of the leading edge sheath 322. In some embodiments, the amount of fiber and/or resin chosen may be based on a desired thickness of the leading edge sheath 322. The desired thickness may be based on a mechanical property of the rotor blade 300. For example, a respective cross-sectional thickness and/or a length of the leading edge sheath 322 may be less at the tip than at the root of the rotor blade 300. The varying cross-sectional thickness and/or length of the leading edge sheath 322 may allow for less fiber and/or resin to be used in the manufacturing process.

The leading edge weight 324 may be disposed on an internal surface of the leading edge sheath 322. In some embodiments, the leading edge weight 324 may include a high-density compression-molding compound and a thermoplastic matrix. The high-density compression-molding compound may include a metallic powder, such as tungsten. However, in other embodiments the high-density compression-molding compound may include a different metallic powder (e.g., lead). In some embodiments, the thermoplastic matrix used in the leading edge weight 324 may be compatible with a material property of the leading edge sheath 322, which may facilitate bonding between the leading edge sheath 322 and the leading edge weight 324. For example, the thermoplastic matrix of the leading edge weight 324 may be the same as and/or similar to the thermoplastic matrix of the leading edge sheath 322. In some embodiments, the amount of high-density compression-molding compound chosen for the leading edge weight 324 may be based on a desired center of gravity location for the respective cross-section of the rotor blade 300. Thus, the leading edge weight 324 may assist in properly balancing the rotor blade 300 by allowing for desired placement of the center of gravity. In some embodiments, the leading edge weight 324 may be welded into the internal surface of the leading edge sheath 322, while in other embodiments the leading edge weight 324 may be co-molded. For example, the leading edge sheath 322 and the leading edge weight 324 may be placed in contact with each other while the respective thermoplastic matrices are in a liquid and/or softened state to allow bonding to occur between the two parts.

In some embodiments, the spar 330 may be a single continuous piece spanning from a root to a tip of the rotor blade 300. In some embodiments, the spar 330 may be made from a composite laminate, such as a thermoplastic composite laminate. For example, the spar 330 may be made from a fiber (e.g., carbon, aramid, or glass) and a thermoplastic matrix. In some embodiments the cross-section of the spar 330 may comprise one or more layers of braided fibers and a thermoplastic matrix. For example, the one or more layers of braided fibers may be formed by layering pre-impregnated thermoplastic composite ribbons around a tool, such as a mandrel. The pre-impregnated thermoplastic composite ribbons may be heated before, during and/or after the layering process to facilitate conformation to the tool shape and/or to promote interaction (e.g., coupling) of the thermoplastic matrix between the layers. In some examples, the spar 330 may be formed by layering dry ribbons of fiber around the tool. The layers of dry ribbons of fiber may then be molded with the thermoplastic matrix, such as via the resin transfer molding process, to form the thermoplastic composite laminate spar.

In some embodiments, the spar 330 may be a single continuous structure comprising two or more parts coupled during manufacturing. For example, the spar 330 may comprise two or more thermoplastic composite laminates coupled together. Each of the two or more thermoplastic composite laminates may form a portion, such as a forward portion and an aft portion or an upper portion and a lower portion, of the spar 330. In some embodiments, each respective portion may be made from heating a pre-impregnated thermoplastic composite laminate sheet to soften the thermoplastic matrix, then stamping (e.g., pressing into a mold) the sheet to the desired configuration. However, in other embodiments, each respective portion may be made by placing fiber plies onto a tool having the desired configuration and applying a thermoplastic matrix to the fiber, such as via resin transfer molding. The two or more thermoplastic composite laminate parts may be joined to form the single continuous structure of the spar 330. In some embodiments, the two or more parts may be joined through welding and/or co-consolidation. Welding and/or co-consolidating may allow fusing to occur between the thermoplastic matrices of the two or more parts which may form a single continuous structure. In some embodiments, the two or more thermoplastic composite laminate parts may be overlapped to facilitate joining. However, in other embodiments, the two or more parts may not be overlapped.

In some embodiments, the spar 330 may comprise one or more layers of braided fibers and one or more composite laminate sheets. For example, the spar 330 may comprise a thermoplastic braided fiber layer and a thermoplastic composite laminate sheet. In some embodiments, one or more layers of braided fiber may be disposed on the mandrel.

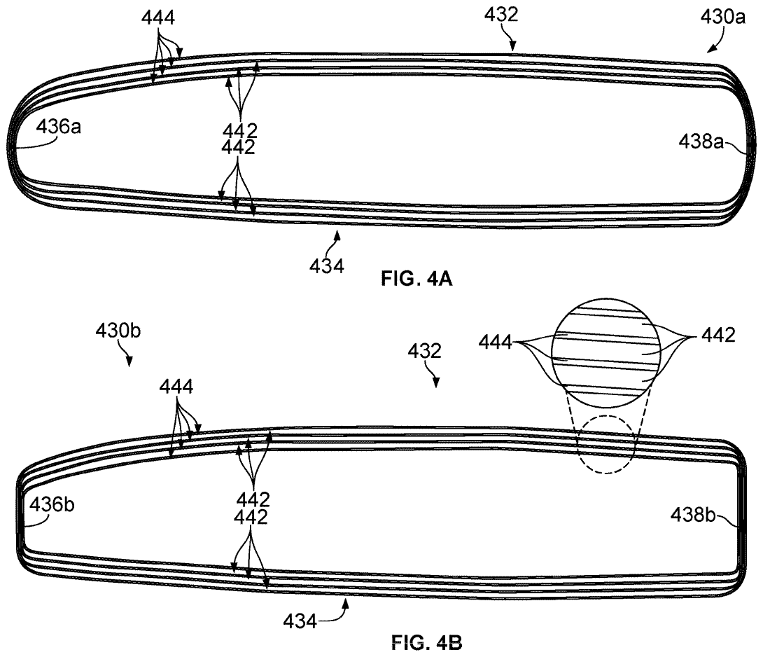

One or more thermoplastic composite laminate sheets may be disposed between desired layers of braided fiber. For example, the thermoplastic composite laminate sheets may be disposed between the desired layers of braided fiber on a portion, such as a first surface and/or a second surface, of the braided fiber disposed on the tool (e.g., the mandrel). Additional layers of braided fiber may be disposed over the thermoplastic composite laminate sheet. In some embodiments, the braided fiber may be pre-impregnated with the thermoplastic matrix, while in other embodiments the thermoplastic matrix may be applied to the braided fibers. To facilitate coupling, heat and/or pressure may be applied to the braided fibers and thermoplastic composite laminate sheets to allow for interaction between the respective thermoplastic matrices and bond the respective parts together. Embodiments in which the spar 330 may comprise one or more layers of braided fibers and one or more composite laminate sheets are discussed in more detail below with respect to FIGS. 4A and 4B.

In some embodiments, the spar 330 may have a closed cross-sectional design (e.g., monocoque), forming an internal cavity within the spar 330. However, in other embodiments, the spar 330 may include one or more stringers, ribs, or other support structure disposed within the cavity formed by the spar 330. As shown in FIG. 3A, the spar 330 may be internally disposed within the rotor blade 300, having a first surface and a second surface, opposite the first surface, coupled to the leading edge assembly 320 and the aft body assembly 350. For example, the first surface may be coupled to the leading edge sheath 322 and an upper aft skin 352 of the aft body assembly 350, and the second surface may be coupled to the leading edge sheath 322 and a lower aft skin 354 of the aft body assembly 350. In some embodiments the first surface may be an upper surface of the rotor blade 300 and the second surface may be a lower surface of the rotor blade 300.

The aft body assembly 350 may include one or more parts, such as the upper aft skin 352 and the lower aft skin 354. In some embodiments, the upper and lower aft skins 352 and 354 may each be made from a single continuous thermoplastic composite laminate sheet. In some embodiments, the upper and lower aft skins 352 and 354 may each include one or more stiffening members 353, such as stringers or ribs. The stiffening members 353 may be integrally molded on a surface of the upper aft skin 352 and/or a surface of the lower aft skin 354, as discussed further in connection with FIGS. 3C and 3D. In some embodiments, a first portion of the upper aft skin 352 may be joined (e.g., welded and/or co-consolidated) to a first portion of the lower aft skin 354 to form a trailing edge joint 358. In additional embodiments, the upper aft skin 352 may be joined to the lower aft skin 354 such that the trailing edge joint 358 may be locally flattened. Locally flattening the trailing edge joint 358 may allow for parallel internal mold line contact between the upper and lower aft skins 352 and 354. In some embodiments, a V-shaped laminate clip, or other suitably shaped laminate structure may be disposed on an internal surface of the aft body assembly 350. In some embodiments, a second portion of the upper aft skin 352 may be joined to a first surface, such as an upper surface, of the spar 330, and a second portion of the lower aft skin 354 may be joined to a second surface, such as a lower surface of the spar 330. The upper and lower aft skins 352 and 354 may be configured to define an aft portion of the cross-section, such as an aft portion of the airfoil cross-section in FIG. 3A.

In some embodiments, the cavity 356 may be defined by an internal space created by the upper aft skin 352 and the lower aft skin 354 between the spar 330 and the trailing edge joint 358. In some embodiments, a material may be disposed within the cavity 356, while in other embodiments no material may be present within the cavity 356. For example, the cavity 356 may have an aft core that may provide structural rigidity to the upper and lower aft skins 352 and 354.

In some embodiments, the aft core may be made from a foam material. For example, an expandable foam material may be injected into the cavity 356 during assembly of the rotor blade 300. The expandable foam material may expand to internal surfaces defining the cavity 356 to substantially fill the cavity 356. The expandable foamed material may solidify (e.g., harden) to provide rigidity to the aft body assembly 350.

In some embodiments, the aft body assembly 350 may be placed in an outer contour mold during injection of the foam material within the cavity 356. The outer contour mold may define a desired shape of the aft body assembly 350, such as defining a contour of the aft portion of the rotor blade 300. The shape of the outer contour mold may allow the foam material to expand to substantially fill the cavity 356 while allowing the upper and lower aft skins 352 and 354 to assume the profile of the outer contour mold. The outer contour mold may allow for the aft body assembly 350 to assume the desired contour while mitigating undesirable contour changes that may otherwise occur from the expanding foam material. However, in other embodiments, a different aft core material may be used, such as a honeycomb panel core.

In some embodiments, the foam material may be injected into the cavity 356 in a particle or granular form and expand to fill the cavity 356 when heated. For example, the rotor blade 300 may be placed into a tool, such as a tool mirroring the outer contour of the rotor blade 300, and heated to soften the thermoplastic matrix for adjustment to be within dimensional tolerance. The foam material may expand during heating to occupy the cavity 356.

However, in other embodiments, the heating temperature for the rotor blade 300 may be above a critical temperature for the foam material (e.g., a temperature at which the mechanical properties of the foam material are negatively impacted). In such embodiments, the rotor blade 300 may be heated and adjusted to be within dimensional tolerance then cooled to an activation temperature for the foam material. The foam material may then be injected into the cavity 356 while the rotor blade 300 is in the tool such that the foam material is allowed to expand and occupy the cavity 356 without altering the shape of the rotor blade 300.

In some embodiments, the aft core material may be integrally formed with either the upper or lower aft skin 352 or 354. The aft skin that does not include the aft core material may be joined to the aft skin including the aft core material. However, in other embodiments the aft core material may be simultaneously joined to both the upper and lower aft skins 352 and 354.

The leading edge assembly 320, the spar 330, and the aft body assembly 350 may be assembled to form a structure, such as the rotor blade 300. For example, a portion of the leading edge assembly 320 and/or a portion of the aft body assembly 350 may be disposed over a portion of the spar 330 such that the spar 330 may be internally disposed within the rotor blade 300. Thus, the leading edge assembly 320 may form a butt joint with the aft body assembly 350. However, in other embodiments, a portion of the leading edge assembly 320 may overlap a portion of the aft body assembly 350 to form a lap joint. In some embodiments, the leading edge assembly 320 may be coupled to the spar 330 at the same time as the aft body assembly 350 is coupled to the spar 330. However, in other embodiments the leading edge assembly 320 may be coupled to the spar 330 before or after the aft body assembly 350 is coupled to the spar 330.

In some embodiments, coupling may be performed by adhesive bonding, co-consolidation, and/or welding, such as induction welding, resistance welding, and/or conductive welding, of the respective parts. To perform this co-consolidation or welding, the thermoplastic matrices of the leading edge assembly 320, the spar 330, and/or the aft body assembly 350 may be softened and/or re-melted fully or locally to the faying surface to increase interaction between the respective thermoplastic matrices. Increased interaction between the respective thermoplastic matrices may produce a stronger joint. In embodiments, the thermoplastic matrix of the spar 330 may be the same and/or similar to the thermoplastic matrix of the leading edge assembly 320 and/or the aft body assembly 350. Using the same and/or similar thermoplastic matrix may increase joint strength due to the same or similar material properties.

In some embodiments, a rigid or semi-rigid support structure, such as an inflatable mandrel (e.g., a bladder) or mandrel, may be disposed within an internal portion of the spar 330 during joining of the leading edge assembly 320 and/or the aft body assembly 350. The support structure may reduce deformation of the spar 330 during joining. For example, during joining of the respective parts, heat and/or pressure may be applied to encourage joining (e.g., interaction between the respective thermoplastic matrices). In some embodiments, this heat or pressure may soften the structure of the spar 330, which may produce undesirable deformation. The support structure may provide rigidity to the spar 330 during the joining to mitigate such undesirable deformation from occurring. The support structure may be removed after processing, such as after the spar 330 has cooled to a desirable temperature at which structural deformations may not occur.

In some embodiments, the leading edge sheath 322, the upper aft body skin 352, and the lower aft body skin 354 may be formed as a single continuous structure defining the outer contour of the airfoil. For example, the single continuous structure may be formed by wrapping braided fiber around an airfoil shaped core. In some embodiments, the airfoil shaped core may include the spar 330, the leading edge weight 324, and/or an aft core material shaped to resemble the aft portion of the rotor blade 300. However, in other embodiments a removable structure may be used in place of the aft core material and may serve as a tool forming the contour of the aft portion of the rotor blade 300 as the braided fiber is applied. The braided fiber may be wrapped around the airfoil shaped core to form the outer contour (e.g. skin) of the rotor blade 300. In some embodiments, the braided fiber may include a thermoplastic matrix, such as pre-impregnated thermoplastic carbon fiber. The braided fiber wrapped core may be heated to fuse the thermoplastic matrix of the single continuous skin structure with the thermoplastic matrices of the airfoil shaped core, such as the thermoplastic matrix of the spar 330. In embodiments using the removable structure in place of the aft core material, the removable structure may be removed before or after the rotor blade 300 is heated to fuse the respective thermoplastic matrices. The removable structure may provide rigidity during the heating process to retain the contour of the aft portion of the rotor blade 300.

In some embodiments, the spar 330, the leading edge assembly 320, and/or the aft body assembly 350 may be manufactured to determined dimensions, such as a determined surface profile and/or a determined twist schedule. In some such embodiments, after joining of the respective parts (e.g. final assembly) the rotor blade 300 may include the determined surface profile and/or the determined twist schedule. In some embodiments, the rotor blade 300 may be determined to be within dimensional tolerance, while in other embodiments the rotor blade 300 may be determined to be out of dimensional tolerance. In some embodiments, where it is determined that the rotor blade 300 is out of dimensional tolerance, the rotor blade 300 may be heated to soften the thermoplastic matrix and then may be adjusted to be within dimensional tolerance.

In some embodiments, a tightly controlled tool may be used to perform the adjustments. Allowing for adjustment of dimensions of the rotor blade 300 after final assembly may increase production rate by allowing for rotor blades to be manufactured with higher tolerances (e.g., less exact manufacturing requirements). Further, post-assembly adjustments may decrease scrap rate of rotor blades that may be determined not to be within tolerance. Thus, manufacturing costs for rotor blades may be decreased by allowing for increased production rates and reduced scrap rate. An example tool is described below in connection with FIG. 8.

FIG. 3B is an exploded cross-sectional view of the rotor blade 300, according to exemplary embodiments of the present invention. As shown in FIG. 3B, the leading edge sheath 322 may comprise a single composite laminate structure that has been formed to a contour of the leading edge of the rotor blade 300. In some embodiments, the cross-sectional shape (e.g., the contour) of the leading edge sheath 322 may vary along the longitudinal length of the rotor blade 300. For example, the contour of the leading edge sheath 322 may be formed to include a determined twist schedule of the rotor blade 300. In some embodiments, the contour of the leading edge sheath 322 may mirror a contour of mating parts, such as the spar 330. For example, the twist schedule of the leading edge sheath 322 may mirror a twist schedule of the spar 330.

The upper and lower aft body skins 352 and 354 may each comprise a composite laminate structure that has been formed to a contour of the aft body of the rotor blade 300. In some embodiments, the cross-sectional shape (e.g., the contour) of the upper and lower aft body skins 352 and 354 may vary along the longitudinal length of the rotor blade 300. For example, the contour of the upper and lower aft body skins 352 and 354 may be formed to include the determined twist schedule of the rotor blade 300.

In some embodiments, the contour of the upper and lower aft body skins 352 and 354 may mirror the contour of mating parts, such as the spar 330. For example, the twist schedule of the upper and lower aft body skins 352 and 354 may mirror the twist schedule of the spar 330. Mirroring the contour of mating parts may allow for proper joining between the spar 330 and internal surfaces of the leading edge sheath 322, the upper aft body skin 352, and/or the lower aft body skin 354 while mitigating residual stresses from arising between the joined parts. Reducing residual stresses from arising between the joined parts may reduce undesirable effects, such as crimping or crippling, from occurring which may affect aerodynamic properties of the rotor blade 300.

FIG. 3C is a cross-sectional view of the rotor blade 300 including the stiffening member 353, according to exemplary embodiments of the present invention. The stiffening members 353 may be formed of any suitable material, for example a thermoplastic composite or a thermoset composite. As shown, the stiffening members 353 may be coupled to at least a portion of a surface of either the upper aft skin 352 and/or the lower aft skin 354, such as an inner surface (e.g., the surface defining the cavity 356). In some examples, the stiffening members 353 may be a separate component coupled to the upper and/or lower aft skin 352 and 354, such as through fasteners and/or adhesive bonding. However, in other examples, the stiffening members 353 may be part of the upper and/or lower aft skin 352 and 354. For example, the stiffening members 353 may be integrally molded on the surface of the upper aft skin 352 and/or a surface of the lower aft skin 354, such as integrally molded during manufacturing. In further examples, the stiffening members 353 may include a thermoplastic resin similar to or the same as the thermoplastic resin of the upper and/or lower aft skin 352 and 354. In such examples, the stiffening members 353 may be integrally formed through welding and/or co-consolidating the thermoplastic resin of the stiffening members 353 with the thermoplastic resin of the upper and/or lower aft skin 352 and 354. In some examples, the stiffening members 353 may provide structural support to the aft body assembly 350, which may allow for the cavity 356 to remain unfilled.

FIG. 3D is a close-up perspective view of a stiffening member 453 that may be included on the upper and/or lower aft skins 352 and 354, according to exemplary embodiments of the present invention. In some embodiments, the stiffening member 453 may be the same as the stiffening member 353. As shown, the stiffening member 453 includes a first plurality of stiffeners 453A and a second plurality of stiffeners 453B disposed on, and outwardly projecting from, a surface of the skin 452 (e.g., the upper and/or lower aft skin). Each stiffer of the first plurality of stiffeners 453A may run parallel to one another. Similarly each stiffener of the second plurality of stiffeners 453B may run parallel to one another. The first plurality of stiffeners 453A may intersect with the second plurality of stiffeners 453B at an angle (e.g., a non-zero angle) to form a geometric pattern. Each point of intersection may form a node 453C. In some examples, the first and second plurality of stiffeners 453A and 453B and the node 453C together may serve to transmit loading throughout the aft body assembly 350 and/or the rotor blade 300. Thus, the stiffening member 453 may provide structural rigidity and load transmission throughout the aft body assembly 300.

While the stiffening member 453 forms a triangular shaped geometric pattern in FIG. 3D, in other examples the stiffening member 453 may form another geometric pattern, such as any polygonal shaped pattern. However, in some examples the stiffening member 453 may not form a geometric pattern. Further, while a first and second plurality of stiffeners 453A and 453B are shown, in other examples another plurality of stiffeners may be used. For example, the stiffening member 453 may include a first plurality of stiffeners; a first, second, and third plurality of stiffeners; a first, second, third, and fourth plurality of stiffeners; a first, second, third, fourth, and fifth plurality of stiffeners; and a first, second, third, fourth, fifth, and sixth plurality of stiffeners. In such examples, one or more of the plurality of stiffeners may be oriented at an angle to another plurality of stiffeners.

FIGS. 4A-4B are cross-sectional views of a spar 430A and 430B, according to exemplary embodiments of the present invention. The spars 430A and 430B may be used on a rotor blade, such as the rotor blade 100-300 shown in FIGS. 1-3C. The spars 430A and 430B may each comprise one or more layers of braided fiber 444 and one or more layers of composite laminate sheets 442. As shown, the composite laminate sheets 442 may be disposed between layers of the braided fiber 444. Thus, the braided fiber 444 may define an inner surface and/or an outer surface of the spar 430A-B.

In some embodiments, the composite laminate sheets 442 may be disposed on one or more portions of the spar 430A and/or 430B. For example, the composite laminate sheets 442 may be disposed on an upper portion 432 and/or a lower portion 434 of the spar 430A and/or 430B. In some embodiments, placement of the composite laminate material 442 may be based on desired mechanical properties of the spar 430A or 430B at the respective portion. For example, placement of the composite laminate sheets 442 at the upper portion 432 and/or the lower portion 434 may increase a cross-sectional thickness at these locations. Increased cross-sectional thickness of the upper and/or lower portion 432 and 434 may increase the moment of inertia of the spar 430A-B which may improve the spar 430A-B transferring loading in service, such as by better transferring forces from bending loads.

In some embodiments, one or more of the composite laminate sheets 442 may be flat, while in other embodiments one or more of the composite laminate sheets 442 might not be flat. For example, the composite laminate sheets 442 may be pre-formed to resemble a profile of the upper and/or lower portion of the spar 430A-B. In embodiments, each of the composite laminate sheets 442 may have a constant cross-sectional thickness, while in other embodiments the cross-sectional thickness may be non-constant. For example, the composite laminate sheets 442 may have a tapered thickness at a respective cross-section of the spar 430A-B such that the thickness of the composite laminate sheets 442 may be greatest at a distance between a forward portion 436A-B and an aft portion 438A-B of the spar 430A-B. Similarly, a thickness of each of the composite laminate sheets 442 may be constant along a longitudinal length in some embodiments, while in other embodiments the thickness may vary along the longitudinal length. For example, the cross-sectional thickness of the composite laminate sheets 442 may be thicker at a root of a rotor blade, such as the rotor blade 200, and thinner towards a tip of the rotor blade. In some embodiments, the composite laminate sheets 442 may be present at each respective cross-section of the rotor blade while in other embodiments the composite laminate sheets 442 may be present at select cross-sections of the rotor blade and not present at other cross-sections.

As shown in FIGS. 4A and 4B, the spar 430A-B may include the forward portion 436A-B and the aft portion 438A-B. In some embodiments, the forward portion 436A-B and/or the aft portion 438A-B may not include the composite laminate sheets 442. However, in other embodiments, one or more of the composite laminate sheets 442 may be disposed between layers of the braided fiber 444 at the forward portion 436A-B and/or the aft portion 438A-B.

FIG. 4A shows the forward portion 436A and the aft portion 438A comprising braided fiber 444 formed to have an arcuate profile. FIG. 4B shows the forward portion 436B and the aft portion 438B comprising braided fiber 444 formed to have a substantially flat profile at a respective cross-section. In some embodiments, the rotor blade may include a twist schedule such that the forward portion 436B and the aft portion 438B may be substantially flat at the respective cross-section but may not be substantially flat along the longitudinal length of the rotor blade. In some embodiments, substantially flat may be exactly flat or one to two standard deviations from exactly flat.

The shape and or number of braided fiber 444 layers at the forward portion 436A-B and the aft portion 438A-B may be based on a desired parameter of the spar 430A-B, such as desired material properties of the spar 430A-B. In some embodiments, the shape of the forward portion 436A-B and the aft portion 438A-B may be based on dimensions of the mating parts, such as the leading edge assembly 320 and/or the aft body assembly 350 of FIG. 3A. A length and/or a thickness of the forward portion 436A-B and/or the aft portion 438A-B may vary at respective cross-sections of the spar 430A-B. For example, the forward portion 436A-B and/or the aft portion 438A-B may be thicker (e.g., comprising more layers of the braided fiber 444) at the root of the rotor blade than towards the rip of the rotor blade.

In some embodiments, one or more parameters for the spar 430A-B may be determined prior to manufacturing. For example, the one or more determined parameters may include a type of braided fiber, a number of layers of braided fiber material, a thickness of each layer of the braided fiber material, a matrix for the braided fiber material, a material and matrix for the composite laminate sheets, a number of composite laminate sheets, a thickness of each composite laminate sheet, and a location of each of the composite laminate sheets. In some embodiments, the one or more determined parameters may be based on design considerations of the spar 430A-B. For example, the one or more determined parameters may be based on design constraints such as determined mechanical properties and/or dimensions (e.g., thickness, width, length, or height) of the spar 430A-B.

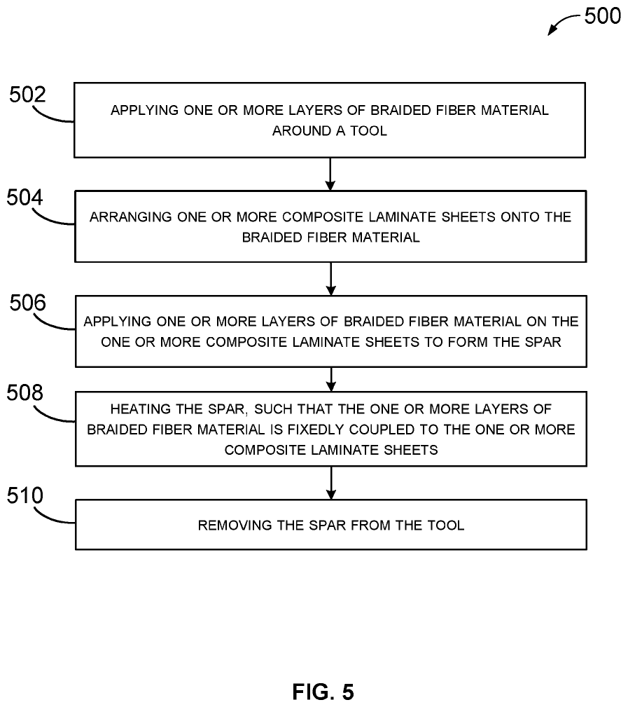

FIG. 5 is a flow chart of an example method 500 for manufacturing a composite laminate structure, according to exemplary embodiments of the present invention. The method 500 may include one or more operations, or actions as illustrated by one or more steps 502-510. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

At step 502 the method 500 may include applying one or more layers of braided fiber material around a tool.

At step 504 the method 500 may include arranging one or more composite laminate sheets onto the braided fiber material.

At step 506 the method 500 may include applying one or more layers of braided fiber material on the one or more composite laminate sheets to form the spar.

At step 508 the method 500 may include heating the spar, such that the one or more layers of braided fiber material is fixedly coupled to the one or more composite laminate sheets.

At step 510 the method 500 may include removing the spar from the tool.

In some embodiments, the method 500 may include applying a thermoplastic matrix to the one or more layers of braided fiber material.

In some embodiments, the braided fiber material comprises a pre-impregnated thermoplastic carbon fiber.

In some embodiments, the one or more composite laminate sheets comprise a thermoplastic matrix.

In some embodiments, heating the spar, such that the one or more layers of braided fiber material is fixedly coupled to the one or more composite laminate sheets is performed by welding.

In some embodiments, heating the spar, such that the one or more layers of braided fiber material is fixedly coupled to the one or more composite laminate sheets is performed by co-consolidating.

In some embodiments, heating may include joining the spar such that the one or more layers of braided fiber material is fixedly coupled to the one or more composite laminate sheets.

In such embodiments, joining the spar may include at least one of co-consolidating, inductive welding, resistance welding, or conductive welding.

In such embodiments, joining the spar may further include applying pressure to a portion of the spar to interact a thermoplastic matrix of the braided fiber material with a thermoplastic matrix of the composite laminate sheets.

In some embodiments, the tool may include at least one of an inflatable mandrel, a multi-piece mandrel, or a preform.

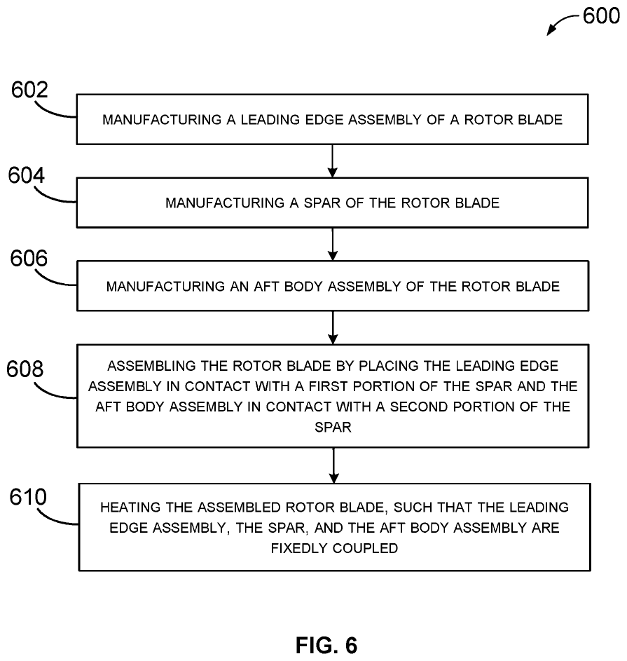

FIG. 6 is a flow chart of an example method 600 for manufacturing a rotor blade, according to exemplary embodiments of the present invention. The method 600 may include one or more operations, or actions as illustrated by one or more steps 602-610. In some embodiments, the one or more operations or actions may be carried out by a robot. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

At step 602 the method 600 may include manufacturing a leading edge assembly of a rotor blade.

At step 604 the method 600 may include manufacturing a spar of the rotor blade.

At step 606 the method 600 may include manufacturing an aft body assembly of the rotor blade.

At step 608 the method 600 may include assembling the rotor blade by placing the leading edge assembly in contact with a first portion of the spar and the aft body assembly in contact with a second portion of the spar.

At step 610 the method 600 may include heating the assembled rotor blade, such that the leading edge assembly, the spar, and the aft body assembly are fixedly coupled.

In some embodiments, the step 602 may include arranging one or more thermoplastic composite plies into a mold, the mold defining an outer contour of a leading edge portion of the rotor blade. The step 602 may also include heating the one or more thermoplastic composite plies, such the one or more thermoplastic composite plies are coupled to form the leading edge assembly.

In some embodiments, the step 604 may be performed by the method 500.

In some embodiments, the step 606 may include arranging one or more thermoplastic composite plies into a first mold, the first mold defining an outer contour of an upper aft body skin. The step 606 may also include heating the one or more thermoplastic composite plies, such the one or more thermoplastic composite plies are coupled to form the upper aft body skin. The step 606 may further include arranging one or more thermoplastic composite plies into a second mold, the second mold defining an outer contour of a lower aft body skin. The step 606 may additionally include heating the one or more thermoplastic composite plies, such the one or more thermoplastic composite plies are coupled to form the lower aft body skin. The step 606 may also include fixedly coupling the upper aft body skin and the lower aft body skin at a first end to form the aft body assembly.

FIGS. 7A-7B are perspective views of example tools 700A and 700B for manufacturing a spar, according to exemplary embodiments of the present invention. As shown in FIG. 7A, the tool 700A may include a braider 710A having one or more braid spools 712A and a mandrel 740A. The one or more braid spools 712A may retain braided fiber 720A. The braider 710A may apply the braided fiber 720A, such as a thermoplastic braid, around the mandrel 740A to form a spar 730A. For example, the braider 710A may wrap the braided fiber 720A around a length of the mandrel 740A. In some examples, the braider 710A may rotate about the mandrel 740A while the braided fiber 720A is being applied, while in other examples the mandrel 740A may rotate about a longitudinal axis as the braided fiber 720A is applied. Further, in some examples, the mandrel 740A may be moved through the braider 710A at a determined feed rate such that the braided fiber 720A is applied along the length of the mandrel 740A. In some such examples, the mandrel 740A may rotate about the longitudinal axis as the mandrel 740A is moved through the braider 710A.

In some examples of the tool 700A the braided fiber 720A may be heated prior to and/or during application onto the mandrel 740A to soften the thermoplastic matrix allowing for improved application. After one or more layers of the braided fiber 720A have been applied to the mandrel 740A, one or more composite laminate sheets (e.g., composite laminate sheets 442) may be applied on top of the braided fiber 720A. In such examples, the tool 700A may repeat wrapping operations of the braided fiber 720A over the mandrel 740A having the composite laminate sheets to form a second layer of the braided fiber 720A. One or more composite laminate sheets may be applied over the second layer of the braided fiber 720A to form a stack. The alternating wrapping of braided fiber 720A and composite laminate sheets along the mandrel 740A may be repeated until a determined thickness of the stack is satisfied. In such examples, the stack may form the spar 730A. The spar 730A may be joined together (e.g., co-consolidated and/or welded), with or without the application of pressure and/or heat, such that the thermoplastic matrices of the braided fiber and composite laminate sheets form a single integrated structure. In examples where joining includes heating, the spar 730A may be cooled to below a determined temperature before being removed from the tool 700A. In some examples, the spar 730A and/or 730B may be the same as or similar to the spar 430A or 430B.

In some examples, the mandrel 740A may define an inner perimeter of the spar 730A. The mandrel 740A may be an inflatable mandrel, a washout mandrel, a multi-piece mandrel, and/or any suitable mandrel capable of producing, and being removable from, a spar having complex geometry, such as a spar having a determined twist schedule.

As shown in FIG. 7B the tool 700B may include one or more braid spools 712B that dispense one or more strands of a braided fiber 720B onto a mandrel 740B. One or more components, features, and/or functions of the tool 700B may be the same as or similar to the tool 700A. For example, the mandrel 740B may rotate about a longitudinal axis as the braided fiber 720B is applied such that the braided fiber 720B is wrapped around the mandrel 740B to form a spar 730B. In some examples, the braid spools 712B may move along a length L of the mandrel 740B while dispensing the braided fiber 720B such that the braided fiber 720B is disposed along the length L. A guide 714 may be used to orient and/or direct an application location of the braided fiber 720B from the braid spools 712B onto the mandrel 740.

FIG. 8 is a perspective view of an example tool 800 for adjusting dimensions of a rotor blade, according to exemplary embodiments of the present invention. The tool 800 may be a negative mold defining an outer contour 810 of a composite laminate part, such as the rotor blade 300. In some examples, the outer contour 810 may be the final dimensions of the rotor blade 300. The tool 800 may be used to correct the rotor blade 300 to be within a determined tolerance for a final rotor blade. For example, where it is determined that the rotor blade 300 is out of dimensional tolerance, the rotor blade 300 may be placed into the tool 800 for correction. Once inside the tool 800, the rotor blade 300 may be heated to soften the thermoplastic matrix allowing for dimensional adjustments to be made to the rotor blade 300. In some examples, pressure may be applied in addition to heating the rotor blade 300 to aid in dimensional adjustments. The rotor blade 300 may be cooled (e.g., to room temperature) while within the tool 800 to allow for the final dimensions to be set.

While the outer contour 810 shown is a negative mold of a half of a composite laminate part, a second negative mold having a second outer contour may be coupled to the outer contour 810 to form a complete outer contour of the composite laminate part. In some examples, the tool 800 may be used for post-assembly adjustments of the rotor blade. Post-assembly adjustments of rotor blades may increase manufacturing output and/or decrease scrap rate by allowing for rotor blades outside of final dimensional tolerance to be adjusted within tolerance instead of scrapping the part.

Implementations of the present disclosure can thus relate to one of the example embodiments listed below.

Embodiment 1 is a method comprising: applying a layer of braided fiber material around a tool; arranging a composite laminate sheet onto the braided fiber material; applying an additional layer of braided fiber material on the composite laminate sheet to form a spar; joining the spar, such that the layers of braided fiber material are fixedly coupled to the composite laminate sheet; and removing the tool from the spar.

Embodiment 2 is the method according to embodiment 1, wherein applying the layer of braided fiber material further comprises heating the braided fiber material.

Embodiment 3 is the method according to embodiment 1 or embodiment 2, wherein the braided fiber material comprises a pre-impregnated thermoplastic carbon fiber.

Embodiment 4 is the method according to any of embodiments 1 to 3, wherein the composite laminate sheet comprises a thermoplastic matrix.

Embodiment 5 is the method according to any of embodiments 1 to 4, wherein the braided fiber material comprises a thermoplastic matrix the same as the thermoplastic matrix of the composite laminate sheet.

Embodiment 6 is the method according to any of embodiments 1 to 5, wherein the tool comprises at least one of an inflatable mandrel, a multi-piece mandrel, or a preform.

Embodiment 7 is the method according to any of embodiments 1 to 6, wherein joining the spar comprises at least one of co-consolidating, inductive welding, resistance welding, or conductive welding.

Embodiment 8 is the method according to any of embodiments 1 to 7, wherein joining the spar further comprises applying pressure to a portion of the spar to interact a thermoplastic matrix of the braided fiber material with a thermoplastic matrix of the composite laminate sheet.

Embodiment 9 is a spar comprising: a first end and a second end, wherein the second end comprises an integrally molded root end joint; and a structure defining a cavity, wherein the structure comprises: a layer of thermoplastic impregnated braided fiber material; and a thermoplastic composite sheet disposed on a portion of the spar between a first layer and a second layer of the thermoplastic braided fiber material, wherein a thermoplastic matrix of the thermoplastic composite sheet is joined with a thermoplastic matrix of the thermoplastic impregnated fiber material.

Embodiment 10 is the spar according to embodiment 9, wherein the thermoplastic matrix of the thermoplastic composite sheet is fused with the thermoplastic matrix of the thermoplastic impregnated fiber material.

Embodiment 11 is the spar according to embodiment 9 or embodiment 10 wherein the layer of thermoplastic impregnated braided fiber material is welded with the thermoplastic composite sheet.

Embodiment 12 is the spar according to any of embodiments 9 to 11, wherein the thermoplastic matrix of the thermoplastic composite sheet is the same as the thermoplastic matrix of the thermoplastic impregnated fiber material.

Embodiment 13 is the spar according to any of embodiments 9 to 12, wherein the spar comprises a monocoque design.

Embodiment 14 is the spar according to any of embodiments 9 to 13, wherein a length of the spar comprises a twist schedule such that a first portion is disposed at an angle to a second portion.

Embodiment 15 is the spar according to any of embodiments 9 to 14, wherein a space defined by the cavity proximal to the first end is less than a space defined by the cavity proximal to the second end.

Embodiment 16 is the spar according to any of embodiments 9 to 15, wherein the structure is a single continuous closed structure.

Embodiment 17 is a rotor blade comprising: a thermoplastic composite spar comprising a first surface, a second surface opposite the first surface, a forward end, and an aft end opposite the forward end; a leading edge assembly comprising a thermoplastic composite skin and disposed at the forward end of the spar, wherein a portion of the thermoplastic composite skin is coupled to the spar on the first and second surfaces, such that a thermoplastic matrix in the portion of the thermoplastic composite skin is fused with a thermoplastic matrix of the spar; and an aft body assembly disposed at the aft end of the spar, the aft body assembly comprising: a first end; a second end opposite the first end; a thermoplastic composite upper skin; and a thermoplastic composite lower skin, wherein the upper skin is coupled to the lower skin at the first end and coupled to the first surface of the spar at the second end, and wherein the lower skin is coupled to the second surface of the spar at the second end.

Embodiment 18 is the rotor blade according to embodiment 17, wherein a thermoplastic matrix of the upper skin is fused with a thermoplastic matrix of the lower skin, and wherein a thermoplastic matrix of the spar is fused with (i) the thermoplastic matrix of the upper skin and (ii) the thermoplastic matrix of the lower skin.

Embodiment 19 is the rotor blade according to embodiment 17 or embodiment 18, further comprising a cavity defined by the aft body assembly, wherein the cavity comprises a foam core.

Embodiment 20 is the rotor blade according to any of embodiments 17 to 19, wherein the upper and lower skin of the aft body comprise an integrally formed stiffening member.

Embodiment 21 is the rotor blade according to any of embodiments 17 to 20, wherein a length of the rotor blade comprises a twist schedule such that a first portion of the rotor blade is disposed at an angle to a second portion of the rotor blade.

While the disclosure discusses manufacture and assembly of various components for rotor blades, the above processes, methods, and devices may be used on any structural and/or non-structural part where manufacture and/or assembly of thermoplastic composite laminate materials may be desired.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting.

Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

What is claimed is:

1. A method comprising:
applying a layer of braided fiber material around a tool;
arranging a composite laminate sheet onto the braided fiber material;
applying an additional layer of braided fiber material on the composite laminate sheet to form a spar;
joining the spar, such that the layers of braided fiber material are fixedly coupled to the composite laminate sheet; and
removing the tool from the spar.

2. The method of claim 1, wherein applying the layer of braided fiber material further comprises heating the braided fiber material, and wherein the braided fiber material comprises a pre-impregnated thermoplastic carbon fiber.

3. (canceled)

4. The method of claim 1, wherein the composite laminate sheet comprises a thermoplastic matrix.

5. The method of claim 4, wherein the braided fiber material comprises a thermoplastic matrix the same as the thermoplastic matrix of the composite laminate sheet.

6. The method of claim 1, wherein the tool comprises at least one of an inflatable mandrel, a multi-piece mandrel, or a preform.

7. The method of claim 1, wherein joining the spar comprises at least one of co-consolidating, inductive welding, resistance welding, or conductive welding.

8. The method of claim 1, wherein joining the spar further comprises applying pressure to a portion of the spar to interact a thermoplastic matrix of the braided fiber material with a thermoplastic matrix of the composite laminate sheet.

9. A spar comprising:
a first end and a second end, wherein the second end comprises an integrally molded root end joint; and
a structure defining a cavity, wherein the structure comprises:
a layer of thermoplastic impregnated braided fiber material; and
a thermoplastic composite sheet disposed on a portion of the spar between a first layer and a second layer of the thermoplastic braided fiber material, wherein a thermoplastic matrix of the thermoplastic composite sheet is joined with a thermoplastic matrix of the thermoplastic impregnated fiber material.

10. The spar of claim 9, wherein the thermoplastic matrix of the thermoplastic composite sheet is fused with the thermoplastic matrix of the thermoplastic impregnated fiber material.

11. The spar of claim 9, wherein the layer of thermoplastic impregnated braided fiber material is welded with the thermoplastic composite sheet.

12. The spar of claim 9, wherein the thermoplastic matrix of the thermoplastic composite sheet is the same as the thermoplastic matrix of the thermoplastic impregnated fiber material.

13. The spar of claim 9, wherein the spar comprises a monocoque design.

14. The spar of claim 9, wherein a length of the spar comprises a twist schedule such that a first portion is disposed at an angle to a second portion.

15. The spar of claim 9, wherein a space defined by the cavity proximal to the first end is less than a space defined by the cavity proximal to the second end.

16. The spar of claim 9, wherein the structure is a single continuous closed structure.

17. A rotor blade comprising:
a thermoplastic composite spar comprising a first surface, a second surface opposite the first surface, a forward end, and an aft end opposite the forward end;
a leading edge assembly comprising a thermoplastic composite skin and disposed at the forward end of the spar, wherein a portion of the thermoplastic composite skin is coupled to the spar on the first and second surfaces, such that a thermoplastic matrix in the portion of the thermoplastic composite skin is fused with a thermoplastic matrix of the spar; and
an aft body assembly disposed at the aft end of the spar, the aft body assembly comprising:
a first end;
a second end opposite the first end;
a thermoplastic composite upper skin; and
a thermoplastic composite lower skin, wherein the upper skin is coupled to the lower skin at the first end and coupled to the first surface of the spar at the second end, and wherein the lower skin is coupled to the second surface of the spar at the second end.

18. The rotor blade of claim 17, wherein a thermoplastic matrix of the upper skin is fused with a thermoplastic matrix of the lower skin, and wherein a thermoplastic matrix of the spar is fused with (i) the thermoplastic matrix of the upper skin and (ii) the thermoplastic matrix of the lower skin.

19. The rotor blade of claim 17, further comprising a cavity defined by the aft body assembly, wherein the cavity comprises a foam core.

20. The rotor blade of claim 17, wherein the upper and lower skin of the aft body comprise an integrally formed stiffening member.

21. The rotor blade of claim 17, wherein a length of the rotor blade comprises a twist schedule such that a first portion of the rotor blade is disposed at an angle to a second portion of the rotor blade.
